(19) United States
(12) Patent Application Publication
(10) Pub. No.: US 2002/0143808 A1
(43) Pub. Date: Oct. 3, 2002

(54) Intelligent document linking system

(76) Inventors: Rodger Miller, Ann Arbor, MI (US); Paul Kassal, Ann Arbor, MI (US); Dan Hepp, Novi, MI (US); Dan LaFavers, Ypsilanti, MI (US)

Correspondence Address: Timothy T. Patula, Esq., PATULA & ASSOCIATES, P.C., 14th Floor, 116 South Michigan Avenue, Chicago, IL, 60603, US

(21) Appl. No.: 09/774,515

(22) Filed: Jan. 31, 2001

(51) Int. Cl. G06F 15/00

(52) U.S. Cl. 707/501.1

(57) ABSTRACT

A method and system for creating hypertext links for all or select proper nouns found in a document or web page on the Internet or world wide web is disclosed. The method and system identifies key terms in a requested document or web page, such as a person or company name, cities, states, and other proper nouns within the natural language text, and marks these terms as hypertext links which when selected offer additional information for that item obtained from information collected and maintained in a knowledge base.

### FIELD OF THE INVENTION

The present invention relates to the Internet, and in particular to technology related to hypertext links. Specifically, the present invention relates to a method and system for creating hypertext links for all or select proper nouns found in a document or web page on the Internet or world wide web. The method and system of the present invention identifies key terms in a requested document or web page, such as a person or company name, cities, states, and other proper nouns within the natural language text, and marks these terms as hypertext links which when selected offer additional information for that item.

### BACKGROUND OF THE INVENTION

The process and communication between an Internet user and any specific website has traditionally been a limited one. In a typical text search interface, the user is restricted to a query window when searching for information that is made available by the site. In order to receive additional information on a specific term, the user would typically have to initiate a new search based on additional terms that were defined in the new query.

The process by which most sites are accessed has been the direct communication between the user's computer and the web site's server. When a user wishes to review or observe a website, they type in a Universal Resource Locator (“URL”) and the user's computer will automatically convert the text search into a numeric host. The user's computer will contact the host and await a response. Upon receiving a response the user will be presented with the information that is presented by the host's server. The user accesses the website's server and the server forwards the information through networks and onto the user's browser. Yet much of the information contained within a page does not include possible backgrounds, or additional information on the completed search.

For example, if a user retrieves a web page having an article relating to George Washington, and the article mentions, for example, Thomas Jefferson or the American Revolution, the user will typically not be able to, unless previously set as a hyperlink on the web page, access additional information on Thomas Jefferson or the American Revolution without leaving that web page and conducting a further search.

The present invention overcomes such limitations by creating hypertext links for any select or all proper nouns in an Internet document or web page within the observed site, prior to displaying the document or page to the user; and thus eliminating the need for having to leave the site and initiate a new search or condensing the current one.

### SUMMARY OF THE INVENTION

The present invention advances the art of web communication, and the techniques of hypertext document linking, beyond which is known to date. The present invention provides a method and system which converts selected proper nouns (e.g., people, places, companies) in an Internet document or web page into hyperlinks which can be used to review additional information about that specific term. The method and system of the present invention can be used to augment any online information and curricula web based products, such as the ProQuest website of Bell and Howell Information and Learning of Ann Arbor, Mich., as well as any other web content.

The present invention comprises three major components. The first component is the marking of proper nouns as hyperlinks, which utilizes a combination of proxy servers and a markup algorithm. The second component is the creation and storage of a knowledge base which supplies the additional information associated with the newly created hyperlinks. The third component is a system which provides process control and inter-process communication, as well as a new source code control system.

The system of the present invention consists of three independent servers which are linked to a web server. The three independent servers are a proxy server, a markup server, and a knowledge base query server.

Operation of the present invention is summarized as follows. When a web page request comes into the web server, the web server will forward the request to the proxy server. The proxy server opens a connection with a remote server containing the requested web page, and begins reading the content of the requested web page. As the page is read from the remote web server, the data is sent to the markup server. The markup server uses a Segmentation Based Recognition algorithm to identify the proper nouns in the requested web page. Once the proper nouns are identified, the markup server inserts hypertext links around those terms and returns the page to the proxy server. The proxy server then returns the page back through the web server, which caches the result and sends it to the web browser that made the original request.

When one of the newly created hypertext links is selected, such a request triggers a knowledge base query. The knowledge base query server, in response to the query, returns on an information page, a list of web pages and web documents stored in the knowledge base query server which are responsive to the query. The user can then select one of the options on the information page, or can continue browsing.

Accordingly, it is the principal object of the present invention to provide a method and system for creating hypertext links for all or select proper nouns found in a document or web page on the Internet or world wide web.

It is another object of the present invention to augment Internet searches and document and/or web page content by converting certain proper nouns (e.g., people, places, companies) into hypertext links which can be used to access additional information about those proper terms.

An additional object of the present invention is to provide a combination of proxy servers which will identify and mark proper nouns as hyperlinks by using an proper noun recognition algorithm.

A further object of the present invention is to create and maintain a knowledge base which can be associated with any proper noun or term, allowing for links to other documents or sites to provide additional information on the proper nouns without requiring additional searching or quitting the present application, document or site.

Yet another object of the present invention is to provide a knowledge base having a data mining and editorial process to populate the knowledge base.

Yet another object of the present invention is to provide a system which provides process control and inter-process communication and a new source code control system for the present invention.

Numerous other advantages and features of the invention will become readily apparent from the detailed description of the preferred embodiment of the invention, from the claims, and form the accompanying drawings in which like numerals are employed to designate like parts throughout the same.

### BRIEF DESCRIPTION OF THE DRAWINGS

A fuller understanding of the foregoing may be had by reference to the accompanying drawings wherein:

FIG. 1 is a schematic diagram of the present invention.

FIG. 2A is an illustration of a web page having been marked with hyperlinks according to the present invention.

FIG. 2B is an illustration of the inserted hypertext for a portion of the web page of FIG. 2A.

FIG. 3 is an illustration of an intermediate web page resulting from the selection of a hyperlink created by the present invention.

FIG. 4 is a schematic diagram of the knowledge base inputs.

FIG. 5 is a chart of the precision and recall rates.

### DETAILED DESCRIPTION OF THE PREFERRED EMBODIMENT

While this invention is susceptible of embodiment in many different forms, there is shown in the drawings and will herein be described in detail, a preferred embodiment of the invention. It should be understood however that the present disclosure is to be considered as an exemplification of the principles of the invention and is not intended to limit the spirit and scope of the invention and/or claims of the embodiment illustrated.

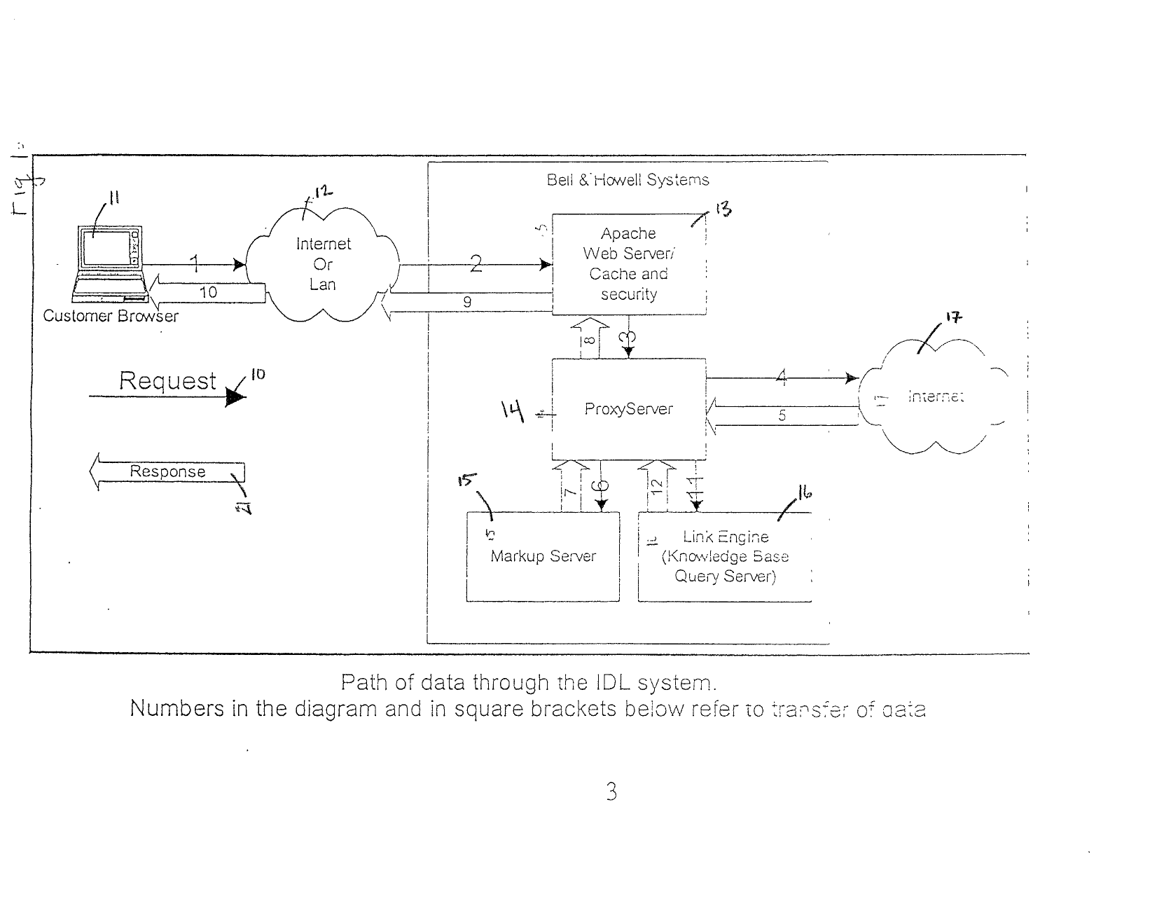

The present invention is schematically illustrated in FIG. 1. The system of the present invention comprises the combination of a proxy server 14, a markup server 15, and a knowledge base query server 16, also referred to as a link engine. The proxy server 14 is operatively connected to a web server 13, for example an Apache web server. The proxy server 14 is further operatively connected to the Internet 17 or other remote servers comprising the world wide web. Thus the proxy server 14 serves as an intermediary between the web server 13 and the Internet 17. The markup server 15 and the knowledge base query server 16 are operatively connected to the proxy server 14 as described in more detail below.

A user's browser 11 is operatively connected through an Internet connection or local area network (LAN) connection 12 to the web server 13. In use, the browser 11 sends a web page request in the form of a URL to the web server 13 via paths of data transfer 1, 2. In the present invention, the web server 13 is preferably used only to provide authentication and caching services.

The web server 13 is configured to forward the request to the proxy server 14 via path of data transfer 3. The proxy server 14 examines the request, and opens a connection with a remote web server on the Internet 17 via path of data transfer 4. The requested information is transferred from the Internet 17 to the proxy server 14 along path of data transfer 5. The proxy server 14 then begins reading the content of the requested web page. As the page is read from the remote web server, the proxy server 14 sends the data to the markup server 16 via path of data transfer 6.

The markup server 16 receives the data (requested web page) and applies a Segmentation Based Recognition (“SBR”) algorithm to identify any or all proper nouns in the requested web page according to the algorithm. SBR is a natural language processing method of recognizing proper nouns using pattern recognition technologies. The algorithm can be defined to recognize any proper nouns or category types such as: Companies, People, Organizations, Facilities, Cities, Countries, FullCities, States, Email addresses, URLs, and Telephone Numbers. Fullcities are distinct from cities in that they are fully specified (e.g., Springfield, Ill. vs. Springfield). The method preferably works on chunks of document text passed to it, rather than requiring the entire document at once. [This means that the browser will see the first part of the page while the remainder of the page is still being processed.] It skips over preexisting links and other HTML fields not appropriate for markup.

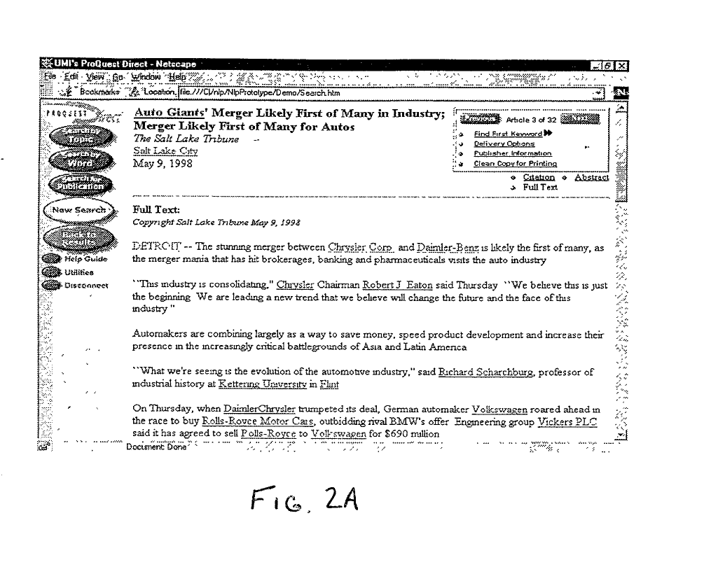

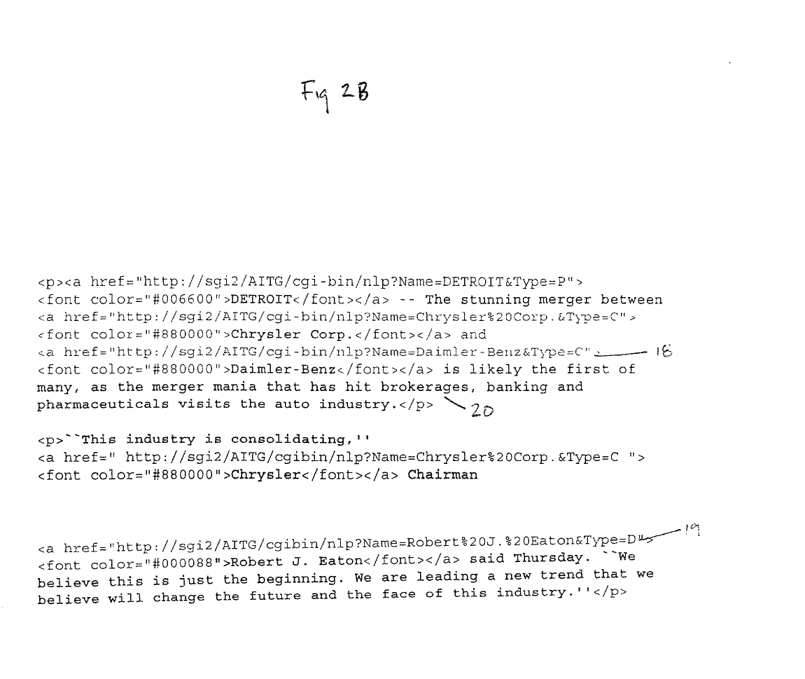

The markup server 16 then inserts hypertext links into the requested web page corresponding to the identified proper noun. These hypertext links also carry additional information as parameters, as will be describe in more detail with respect to FIG. 2.

After inserting the hypertext links into the requested web page, the markup server 16 then returns the requested web page to the proxy server 14 via path of data transfer 7. The proxy server 14 then delivers the requested web page to the web server 13 via path of data transfer 8. The web server 13 caches the result and sends it via paths of data transmission 9, 10 to the web browser 11 that made the original request. As a result, the document or page that the user has requested has been presented to the user with all or select proper nouns as hyperlinks. The user is thus able to select any such hyperlink to retrieve additional information for that proper noun.

FIG. 2A illustrates an Internet document or web page that has been marked with hyperlinks according to the present invention. As can be seen the proper nouns, i.e., “DETROIT”, “Chrysler Corp.”, “Daimler-Benz”, etc., have been marked as hyperlinks.

FIG. 2B shows the source code of the inserted hypertext for the first two paragraphs in the web page of FIG. 2A. The inserted hypertext includes a URL with parameters. The first part of the inserted URL is the domain name that sends a request to the knowledge base lookup program. The parameter part of the URL, the part following the “?”, has a first parameter comprising the marked text, with the spaces encoded as hexadecimal. The second parameter, “Type”, identifies the marked text by a category identified by a category reference letter. This information was added by the markup server 15.

By way of example, the insertion of hypertext links into the content of an Internet document or web page is illustrated in the following table:

TABLE 1

| | |
|---|---|
| | Marked Up Content |
| Original Content | (Hypertext insertion) |

| | |
|---|---|
| To them, issues are less | To them, issues are less important |
| important than whether | than whether <a |
| Bush has the combination | href=“http://www.proquest.com/cgi- |
| of name recognition, | bin/ibrowse/ibrowse.cgi?Name=George%2 |
| personality, and | OW%20Bush&Type=B>Bush</a> has the |
| fundraising ability to | combination of name recognition, |
| make him a winner. | personality, and fundraising ability |
| | to make him a winner. |

In the marked up content, the proper noun “Bush” is surrounded with inserted hypertext link tags. The first part to the hypertext insertion is the URL “http://www.proquest.com/cgi-bin/ibrowse/ibrowse.cgi”. The next part of the insertion is the first parameter “Name=George%20W%20Bush”. The final part of the insertion is the second parameter “Type=B”.

The first parameter or name parameter identified by the markup server 15 will contain a full name whenever possible. If the name “John Smith” appears in the document, the markup algorithm will highlight or hyperlink the word “Smith” when it appears by itself, but it will include the complete name, “John Smith” as the name parameter of the URL, as was done in the example of Table 1. This process, called emendation, increases the precision of the knowledge base query results.

When one of created hyperlinks, for example “Robert J. Eaton” as shown in FIG. 2A, is selected by the end user, the browser will send a new page request 10 to the web server 13, as shown in FIG. 1. This page request 10 is forwarded to the proxy server 14, but instead of going out to the Internet 17, the proxy server 14 sends the request 10 to the knowledge base query server 16, using a CGI script written in Perl.

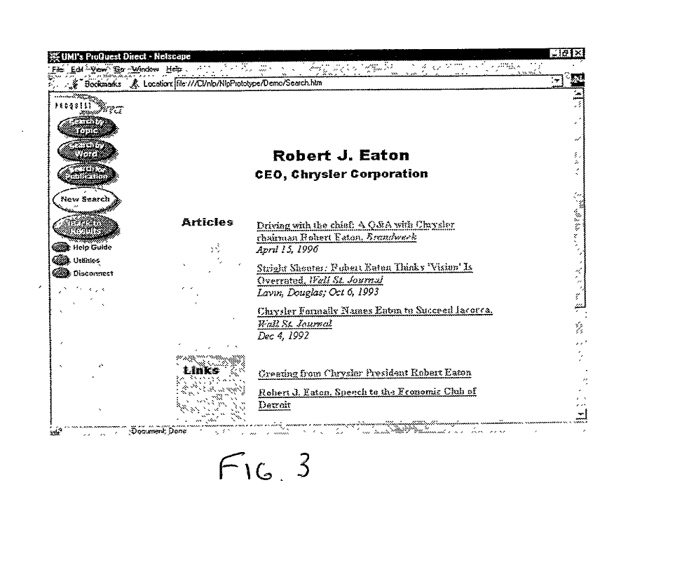

CGI is the Common Gateway Interface standard for using forms on the web. In this case it is used to send information from the document, for example, a person's name, so that person can be found in the knowledge base. The CGI script sends a request, e.g., “Robert J. Eaton”, to the knowledge based query server 16, which returns an information page (FIG. 3) containing a list of web pages and other documents corresponding to that request.

The information page, shown in FIG. 3, contains two types of items. First, the information page includes a list of articles and direct links which have been stored in the knowledge base. These are static, pre-selected articles and links that have been collected through a variety of data mining techniques. These links will display a specific article, or will take the user to a specific page on an external site.

Second, the information page includes a set of buttons to perform searches for the item on various third party databases. The external databases that are used vary based on the type or category of the entity being searched. For example, information pages for people could contain links to the web site “Biography.com”, while company names could contain links to the website “Hoovers.com”. The user can then select one of these options on the information page, or can continue browsing. Every page the user sees is sent though the markup server.

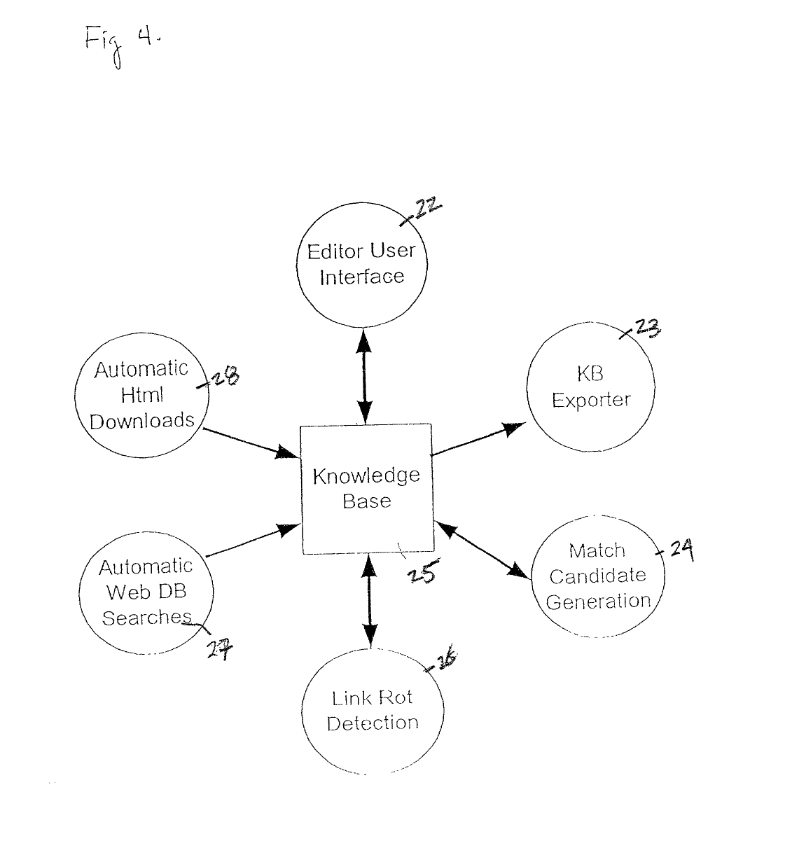

As indicated above, the knowledge base data is served up by the Link Engine or knowledge base query server 16. The Link Engine is a persistent application that can answer queries posed to it in it's own query language. It provides high-speed access to the data. The data is periodically refreshed from the knowledge base preparation processes described below with respect to FIG. 4.

As illustrated in FIG. 4, the entity specific information comprising the knowledge base 25, and which appears on the intermediate pages (e.g., FIG. 3) created by the link engine, can be collected in a variety of ways: for example, through a manual work process entered via an editor user interface 22, through a process for automatic extraction from HTML pages 28, and with automatic methods which search web databases 27.

With the process for automatic extraction from HTML pages 28, it is possible to keep up with ever changing content, such as major league sports. The use of automatic extraction from web database searches 27 will maximize the perceived precision level of the knowledge base and of the web sites linked to on the intermediate pages. These automated collection techniques result is multiple targets for many entities, without the need for costly and time consuming manual work methods, which remains an option when necessary.

Additional tools to help maintain the knowledge base include Link Rot detection tools 26, Match candidate generation tools 24, and knowledge base exporter tools 23. Link Rot detection tools 26 can be used to automatically detect web links and searches which can no longer be loaded and are therefore out of date. These out of date links are flagged for review and shut off. Match Candidate Generation tools 24 can be used to accomplish merging of entities. When the knowledge base contains more than one entity with the same name, the knowledge base will contain two different sets of information. The actual technology of the match candidate generation module involves fuzzy match techniques to flag entities for review. This capability would enable automatic detection of variants such as Bill Gates and William Henry Gates. The knowledge base exporter tool is used to create a flat file for mapping to Link Engine format.

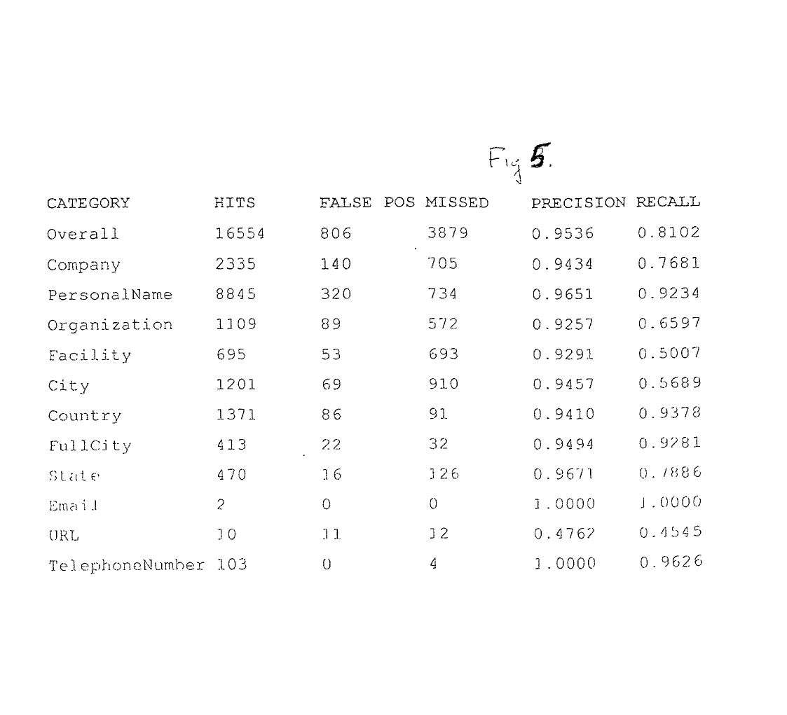

The proper noun recognition capacity of the present invention is measured by two important factors: precision and recall. Precision is the fraction of system responses which are correct. Recall is the fraction of total entities in the set which have been correctly recognized. Precision and recall generally work against one another so in order to improve recall, a system must be made more aggressive, which typically results in an increased error rate and a decrease in precision. The present invention attains a level near 95 percent (See FIG. 5).

The invention further includes a process control and communication systems, called Novus; and the source code control system, called Domino.

Novus is a dynamic process control and inter-process communication framework for client-server applications. Specifically, Novus provides the services of maintaining a directory of all services running under the program. If a service is available on multiple machines, the clients will select different machines in a round-robin fashion. This service directory is updated dynamically, allowing processes to be moved to different machines or to be started and shut down at different times of the day to support changing demands of the system. The dynamic configuration can be done without taking the system down and without the loss of service to the clients.

Novus further provides request queuing and process monitoring. Servers run under a controller process called a service manager that queues requests and dispatches them to the individual servers. If a server dies, it is restarted without losing pending requests.

Novus also consists of development tools to define and implement the interface between the clients and server processes. To exchange these messages, clients and servers use the Novus messenger library, which implements a Reliable Datagram Protocol (RDP) on top of the UDP protocol. In essence, Novus servers can use stream oriented interfaces, such as HTTP, or custom message services that exchange fixed size messages.

The Domino source code control is essentially a build and version control system that uses RCS to manage the archiving of individual files and Perl instead of makefiles. Its characteristics include treatment of each software module as an object that knows how to build itself, and inherent tracking of software module versions and dependencies.

While the specific embodiments have been illustrated and described, numerous modifications come to mind without significantly departing from the spirit of the invention and the scope of protection is only limited by the scope of the accompanying Claims.

What is claimed is:

1. A system for creating hyperlinks for select terms in a requested document, said system comprising:
means for identifying the select terms in the requested document; and
means for inserting hypertext links around the select terms.

2. The system of claim 1, further comprising means for storing a knowledge base.

3. The system of claim 2, wherein upon selection of one of said inserted hypertext links, said means for storing returns a list of links to information from said knowledge base, related to the selected hypertext link.

4. The system of claim 2, further comprising means for populating the knowledge base.

5. The system of claim 1, wherein said select terms are proper nouns.

6. A system for creating hyperlinks for select terms in a web page on a remote server, requested by a web browser through an associated web server, said system comprising:
a proxy server for receiving the web page request from the web server, and for retrieving the requested web page from the remote server;
a markup server for receiving the requested web page from the proxy server, wherein said markup server identifies the select terms in the requested web page, inserts hypertext links around the select terms, and returns the requested web page to said proxy server;
wherein said proxy server returns the requested web page to the web server, which sends the requested web page to the web browser.

7. The system of claim 6, further comprising a knowledge base query server for storing a knowledge base.

8. The system of claim 7, wherein upon selection of one of said inserted hypertext links, said knowledge base query server returns a list of links to information, stored in said knowledge base, related to the selected hypertext link.

9. The system of claim 7, further comprising means for populating the knowledge base.

10. The system of claim 6, wherein said select terms are proper nouns.

11. A method of creating hyperlinks for select terms in a requested document, said method comprising the steps of:
identifying the select terms in the requested document; and
inserting hypertext links around the select terms.

12. The method of claim 11, further comprising the step of storing a knowledge base.

13. The method of claim 12, further comprising the step of returning a list of links to information from said knowledge base, upon selection of one of said inserted hypertext links.

14. The method of claim 12, further comprising the step of populating the knowledge base.

15. The method of claim 11, wherein said select terms are proper nouns.

16. A method of creating hyperlinks for select terms in a web page on a remote server, requested by a web browser through an associated web server, said method comprising the steps of:
receiving via a proxy server the web page request from the web server;
retrieving via the proxy server the requested web page from the remote server;
receiving via a markup server the requested web page from the proxy server;
identifying via the markup server the select terms in the requested web page;
inserting hypertext links around the select terms; and
returning the requested web page with inserted hypertext links to said web browser.

17. The method of claim 16, further comprising the step of storing a knowledge base.

18. The method of claim 17, further comprising the step of returning a list of links to information from said knowledge base, upon selection of one of said inserted hypertext links.

19. The method of claim 17, further comprising the step of populating the knowledge base.

20. The method of claim 16, wherein said select terms are proper nouns.
